(19) United States
(12) Patent Application Publication
(10) Pub. No.: US 2018/0143578 A1
(43) Pub. Date: May 24, 2018

(54) IMAGE FORMING SYSTEM, METHOD OF CONTROLLING IMAGE FORMING SYSTEM, AND POST-PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventor: Mitsunori ISHII, Ota Tokyo (JP)

(21) Appl. No.: 15/728,697

(22) Filed: Oct. 10, 2017

Related U.S. Application Data
(63) Continuation-in-part of application No. 15/356,080, filed on Nov. 18, 2016.

(51) Int. Cl. G03G 15/00

(52) U.S. Cl. CPC G03G 15/6544

(57) ABSTRACT

A post-processing apparatus according to an embodiment includes a binding unit, a tray, a conveying unit and a reversing unit. The binding unit binds a plurality of sheets together at a binding position of the sheets to form a sheet bundle. The conveying unit conveys the sheet bundle along a first path toward the tray. The reversing unit is arranged along the first path between the conveying unit and the tray. The reversing unit includes a second path and is controlled to convey the sheet bundle from the first path to the second path and then from the second path to the first path to reverse a surface of the sheet bundle from a face-up position to a face-down position.

### CROSS-REFERENCE TO RELATED APPLICATIONS

This application is a continuation-in-part of U.S. patent application Ser. No. 15/356,080, entitled “IMAGE FORMING SYSTEM, METHOD OF CONTROLLING IMAGE FORMING SYSTEM, AND POST-PROCESSING APPARATUS”, filed Nov. 18, 2016, (Attorney Docket No. TAI/1600US), all of which are incorporated by reference in their entireties.

### FIELD

Embodiments described herein relate generally to an image forming system and a method of controlling the image forming system.

### BACKGROUND

There is an image forming system provided with an image forming unit and a stapling unit. The image forming unit forms an image on a sheet. The stapling unit staples multiple sheets together. The image forming system discharges the stapled sheets to a discharge tray. However, when multiple stapled sheet bundles are discharged to the discharge tray and stacked, portions having the staples may accumulate higher than portions not having the staples so that the stack of bundles is not flat. Therefore, the stacked sheets may collapse.

### DESCRIPTION OF THE DRAWINGS

FIG. 1 is a schematic diagram illustrating an example configuration of an image forming system according a first embodiment.

FIG. 2 is a schematic block diagram illustrating an example configuration of functional blocks of the image forming system.

FIG. 3 is a diagram illustrating a binding unit of the image forming system.

FIG. 4 is a diagram illustrating an example of an offset unit.

FIG. 5 is a flowchart illustrating an example sequence of operations for controlling the image forming system of the first embodiment.

FIG. 6 is a front view illustrating a stacking state of sheet bundles when a normal printing operation is performed.

FIG. 7 is a side view illustrating the stacking state of the sheet bundles when the normal printing operation is performed.

FIG. 8 is a front view illustrating a stacking state of sheet bundles when a stacking state priority operation is performed.

FIG. 9 is a side view illustrating the stacking state of the sheet bundles when the stacking state priority operation is performed.

FIG. 10 is a front view illustrating a stacking state of sheet bundles when an offset discharge operation is performed.

FIG. 11 is a plan view of a front-surface oriented sheet bundle.

FIG. 12 is a plan view of a rear-surface oriented sheet bundle.

FIG. 13 is a diagram illustrating a distribution state of the sheet bundles when a front and rear alternating printing operation is performed.

FIG. 14 is a front view illustrating a stacking state of sheet bundles when the front and rear alternating printing operation is performed.

FIG. 15 is a plan view of a vertically oriented printing sheet bundle.

FIG. 16 is a plan view of a horizontally oriented printing sheet bundle.

FIG. 17 is a diagram illustrating a distribution state of the sheet bundles when the vertical and horizontal alternating printing operation is performed.

FIG. 18 is a front view illustrating a stacking state of the sheet bundles when the vertical and horizontal alternating printing operation is performed.

FIG. 19 is a front view illustrating a stacking state of the sheet bundles when the vertical and horizontal alternating printing and the offset discharge operations are performed in combination.

FIG. 20 is a schematic diagram illustrating an example configuration of an image forming system according to a second embodiment.

FIG. 21 is a schematic diagram illustrating an example configuration of a reversing unit of the image forming system according to the second embodiment.

FIG. 22 is a schematic block diagram illustrating an example configuration of functional blocks of a post-processing apparatus of the second embodiment.

FIG. 23 is a conceptual plane view illustrating output results of each of four discharge modes.

FIG. 24 is a table showing examples of different jobs and the discharge mode selected for each of the different jobs stored in storage of the second embodiment.

FIG. 25 is a flow chart of a post-processing operation according to the second embodiment.

FIG. 26 is a schematic diagram illustrating a movement of each elements of the reversing unit when the normal discharge mode is performed.

FIGS. 27-30 are schematic diagrams illustrating a movement of each elements of the reversing unit when the reversing operation is performed.

### DETAILED DESCRIPTION

A post-processing apparatus according to an embodiment includes a binding unit, a tray, a conveying unit and a reversing unit. The binding unit binds a plurality of sheets together at a binding position of the sheets to form a sheet bundle. The conveying unit conveys the sheet bundle along a first path toward the tray. The reversing unit is arranged along the first path between the conveying unit and the tray. The reversing unit includes a second path and is controlled to convey the sheet bundle from the first path to the second path and then from the second path to the first path to reverse a surface of the sheet bundle from a face-up position to a face-down position.

### First Embodiment

Hereinafter, the image forming system of a first embodiment will be described with reference to the drawings. In the drawings, the same configurations will be denoted by the same reference numerals.

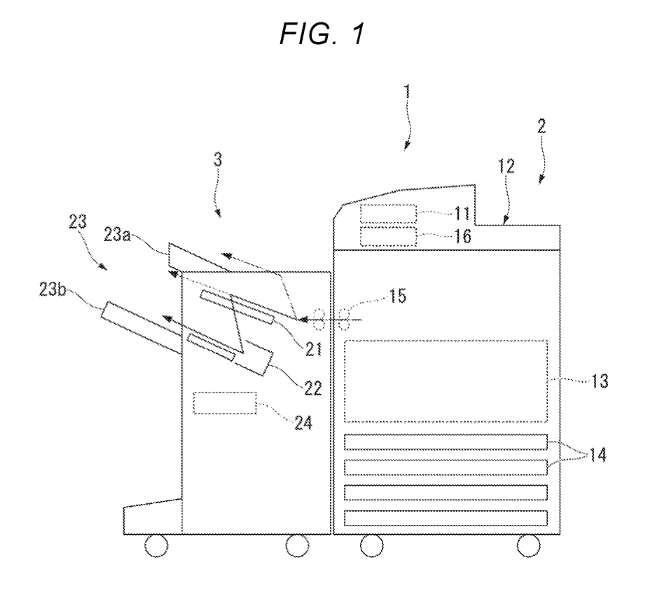

FIG. 1 is a schematic diagram illustrating an example configuration of an image forming system 1 of the first embodiment.

As illustrated in FIG. 1, the image forming system 1 includes an image forming apparatus 2 and a post-processing apparatus 3.

First, the image forming apparatus 2 will be described. The image forming apparatus 2 forms an image on a recording medium (hereinafter, referred to as “sheet”) such as paper. For example, the image forming apparatus 2 is a multi-function peripheral (MFP). The image forming apparatus 2 includes a control panel 11, a scanner unit 12, a printer unit 13 (image forming unit), a paper feeding unit 14 (supply unit), a paper discharge unit 15, and an image forming control unit 16 (control unit).

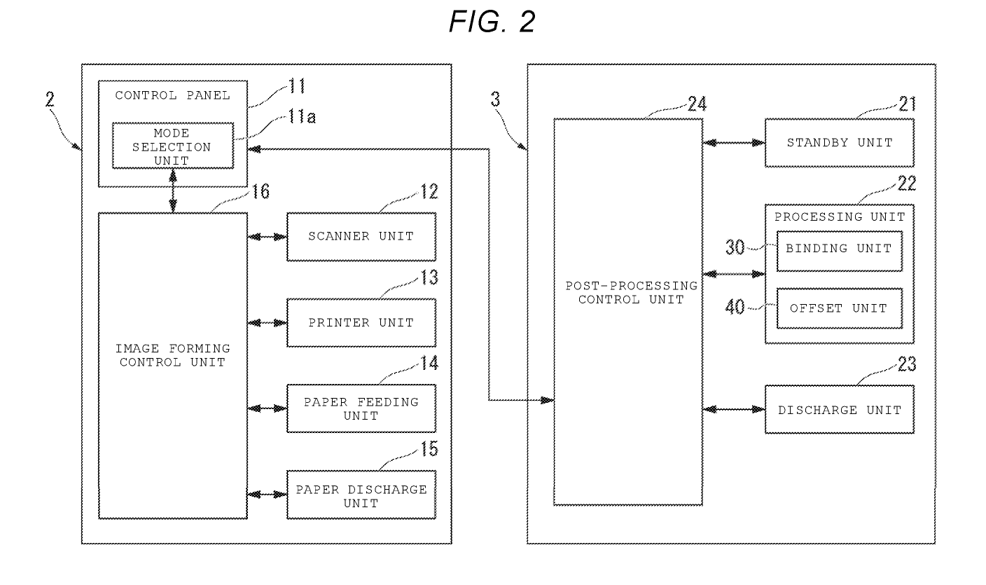

The control panel 11 includes various keys adapted to receive an operation of a user. The control panel 11 is configured to provide a mode selection unit 11a (see FIG. 2) that allows a user to select various modes. For example, the control panel 11 receives an input selecting a type of post-processing of the sheet. For example, the control panel 11 receives the selection of a sort mode, a staple mode, or a non-sort mode. Here, the “sort mode” means a mode in which sorting is performed. The “staple mode” means a mode in which stapling is performed. The “non-sort mode” means a mode in which neither sorting and stapling is performed. When the non-sort mode is selected, the control panel 11 provides the user with a selection of whether to discharge a sheet S to a discharge tray 23a or a discharge tray 23b. The control panel 11 sends information about the selected type of post-processing to the post-processing apparatus 3.

The scanner unit 12 reads a scanning object and generates image data corresponding to the scanning object. The scanner unit 12 sends the image data to the printer unit 13.

The printer unit 13 forms an image (hereinafter, referred to as “toner image”) with a developer such as a toner based on the image data sent from the scanner unit 12 or from an external device. The printer unit 13 transfers the toner image onto a surface of a sheet. The printer unit 13 fixes the toner image to the sheet by applying a pressure and heat to the toner image transferred onto the sheet.

The paper feeding unit 14 supplies sheets to the printer unit 13 one by one. The paper feeding unit 14 may include a first medium storage unit and a second medium storage unit.

The paper discharge unit 15 transports the sheet discharged from the printer unit 13 to the post-processing apparatus 3.

FIG. 2 is a schematic block diagram illustrating an example of a configuration of functional blocks of the image forming system 1.

As illustrated in FIG. 2, the image forming control unit 16 controls the all operations of the image forming apparatus 2. That is, the image forming control unit 16 controls the control panel 11, the scanner unit 12, the printer unit 13, the paper feeding unit 14, and the paper discharge unit 15. The image forming control unit 16 includes a control circuit including a CPU, a ROM, and a RAM.

Next, the post-processing apparatus 3 will be described. As illustrated in FIG. 1, the post-processing apparatus 3 is adjacent to the image forming apparatus 2. The post-processing apparatus 3 executes the post-processing specified through the control panel 11 on a sheet transported from the image forming apparatus 2. For example, the post-processing may be stapling or sorting. The post-processing apparatus 3 includes a standby unit 21, a processing unit 22, a discharge unit 23, and a post-processing control unit 24.

The standby unit 21 allows a sheet transported from the image forming apparatus 2 to be temporarily held therein. For example, the standby unit 21 may hold one or more subsequent sheets to stand-by during the post-processing of sheets already in the processing unit 22. The standby unit 21 is provided above the processing unit 22. When the processing unit 22 is empty, the standby unit 21 drops the staying sheets toward the processing unit 22.

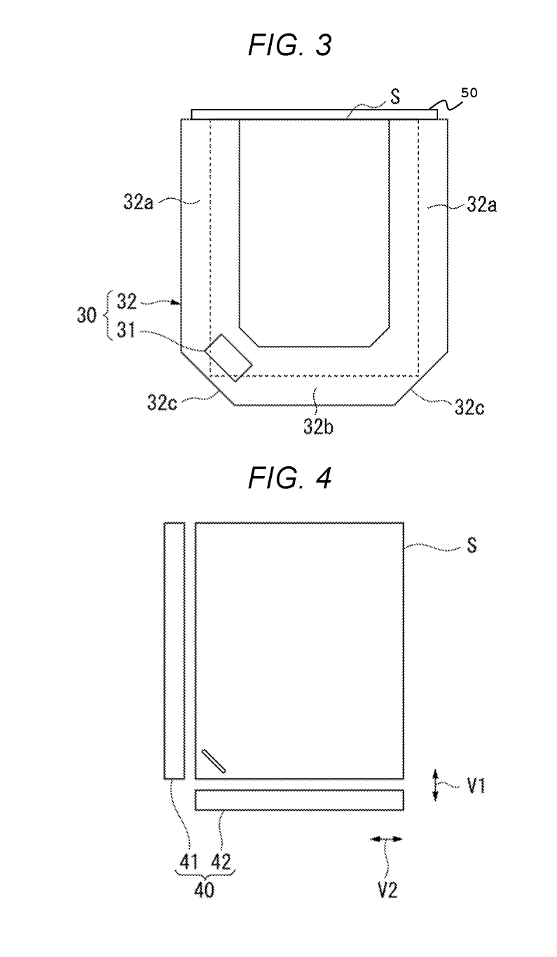

The processing unit 22 subjects sheets to post-processing. For example, the processing unit 22 aligns a plurality of sheets. The processing unit 22 includes the binding unit 30 (see FIG. 3), an offset unit 40 (see FIG. 4), and a stacking unit 50 (see FIG. 3). The stacking unit 50 receives and stacks a sheet transported from the image forming apparatus.

FIG. 3 is a diagram illustrating an example of the binding unit 30 of the first embodiment.

As illustrated in FIG. 3, the binding unit 30 includes a stapler 31 and a guide rail 32. The stapler 31 binds a plurality of sheets S together with a needle. When viewed from the top, the guide rail 32 forms a U-shape along three sides of a rectangular sheet S. The guide rail 32 includes first rail portions 32a, a second rail portion 32b, and third rail portions 32c. When viewed from the top, the first rail portions 32a linearly extend along long sides of a sheet S. When viewed from the top, the second rail portion 32b linearly extends along a short side of a sheet S. When viewed from the top, the third rail portions 32c extend in directions intersecting and inclined relative to the first rail unit 32a and the second rail unit 32b. The stapler 31 is movable along the guide rail 32 by a driving unit (not shown). The stapler 31 can bind sheets S at an arbitrary position on the guide rail 32.

By virtue of the configuration, the binding unit 30 staples a plurality of aligned sheets S together. Accordingly, the plurality of sheets S are bound together, and thus a sheet bundle is obtained.

FIG. 4 is a diagram illustrating an example of the offset unit 40 of the first embodiment.

As illustrated in FIG. 4, the offset unit 40 includes a first slider 41 and a second slider 42.

Hereinafter, a direction parallel to a transport direction of a sheet S will be referred to as a first direction (arrow V1 in the drawings). In addition, a direction intersecting the transport direction of a sheet S will be referred to as a second direction (arrow V2 in the drawings). In the first embodiment, the “transport direction of a sheet S” means a transport direction of a sheet S (including a sheet bundle) with respect to the discharge tray 23a or 23b. In the first embodiment, the second direction is a direction perpendicular to the transport direction of a sheet S. In FIG. 4, the first direction V1 coincides with a long edge of a sheet S, and the second direction V2 coincides with a short edge of a sheet S.

When viewed from the top, the first slider 41 extends in the first direction V1. The first slider 41 is movable in the second direction V2 by a driving unit (not shown). When viewed from the top, the second slider 42 extends in the second direction V2. The second slider 42 is movable in the first direction V1 by a driving unit (not shown).

By virtue of the configuration, the offset unit 40 shifts sheet bundles in the first direction V1 or the second direction V2. Accordingly, the sheet bundles shifted in the first direction V1 or the second direction V2 are discharged to the discharge tray 23a or 23b.

As illustrated in FIG. 1, the processing unit 22 discharges the sheet S subjected to the post-processing to the discharge unit 23.

The discharge unit 23 includes the discharge trays 23a and 23b to which sheets S are discharged. The discharge trays 23a and 23b receives sheets or sheet bundles. The discharge tray 23a is provided in an upper part of the post-processing apparatus 3. For example, the discharge tray 23a may be a fixed tray. The discharge tray 23b is provided in a side portion of the post-processing apparatus 3. For example, the discharge tray 23b may be a movable tray.

As illustrated in FIG. 2, the post-processing control unit 24 controls the overall operation of the post-processing apparatus 3. That is, the post-processing control unit 24 controls the standby unit 21, the processing unit 22, and the discharge unit 23. The post-processing control unit 24 includes a control circuit including a CPU, a ROM, and a RAM.

Hereinafter, the image forming control unit 16 and the post-processing control unit 24 will be collectively called “control unit”. The control unit controls the printer unit 13 and the binding unit 30 such that binding positions related to a first sheet S (first recording medium) and a subsequent second sheet S (second recording medium) are distributed in the first direction V1 or the second direction V2. Here, the first sheet S means an arbitrary sheet which is discharged to the discharge unit 23. The second sheet S means a sheet which is different from the first sheet S and which is discharged to the discharge unit 23 after the first sheet S. That is, the control unit controls the distribution of the binding positions by making the image forming apparatus 2 and the post-processing apparatus 3 cooperate. The control unit controls at least one of the printer unit 13, the paper feeding unit 14, the binding unit 30, and the offset unit 40 according to a stack mode or a print mode.

A stacked sheet number priority mode (first mode) and a stacking state priority mode (second mode) can be selected through the mode selection unit 11a. Here, the “stacked sheet number priority mode” means a mode in which binding positions related to a first sheet S and a second sheet S are distributed in the first direction V1 or the second direction V2. That is, the “stacked sheet number priority mode” is a mode in which collapse of sheets S stacked in the discharge tray 23a or 23b is suppressed to put priority on increasing the number of sheets S stacked. The “stacking state priority mode” means a mode in which binding positions related to a first sheet S and a second sheet S are in a fixed position without being distributed in the first direction V1 or the second direction V2. That is, the “stacking state priority mode” is a mode in which priority is put on improving the stacking state of sheets S while the possibility of collapse of the stacked sheets S is left.

Next, an example of the control of the control unit in the stacked sheet number priority mode will be described.

For example, the control unit controls the printer unit 13 such that front-surface printing and rear-surface printing are alternately performed. In addition, the control unit controls the binding unit 30 such that binding positions related to sheets S subjected to front-surface printing and binding positions related to sheets S subjected to rear-surface printing are distributed in the first direction V1 or the second direction V2. Here, the “front-surface printing” means forming an image on a first surface (front surface) of a sheet S. The “rear-surface printing” means forming an image on a second surface (rear surface) on an opposite side to the first surface of the sheet S.

The paper feeding unit 14 supplies vertically oriented sheets and horizontally oriented sheets. Here, the “vertically oriented sheet” means a sheet S having the longer edge in the first direction V1. The “horizontally oriented sheet” means a sheet S having the shorter edge in the first direction V1 (that is, having the longer edge in the second direction V2).

For example, the control unit controls the paper feeding unit 14 such that vertically oriented sheets and horizontally oriented sheets are alternately supplied. In addition, the control unit controls the binding unit 30 such that binding positions related to vertically oriented sheets and binding positions related to horizontally oriented sheets are distributed in the first direction V1 or the second direction V2.

For example, the control unit controls the offset unit 40 to shift a sheet S which is discharged to the discharge tray 23a or 23b in the first direction V1 or the second direction V2.

Next, the method of controlling the image forming system of the first embodiment will be described.

The method of controlling the image forming system includes an image forming step, a binding step, and a distribution step. In the image forming step, an image is formed on a sheet S. In the binding step, a plurality of sheets S each having the image formed thereon are bound together to forma sheet bundle. In the distribution step, binding positions of a first sheet bundle and a second sheet bundle are distributed in the first direction V1 or the second direction V2.

In the image forming step, front-surface printing and rear-surface printing are alternately performed. In the binding step, binding positions of the front-surface printed sheets and binding positions related to rear-surface printed sheets are distributed in the first direction V1 or the second direction V2.

The method of controlling the image forming system further includes a supply step for supplying vertically printed sheets and horizontally printed sheets. In the supply step, the vertically printed sheets and the horizontally printed sheets are alternately supplied. In the distribution step, binding positions of the vertical printed sheets and binding positions of the horizontal printed sheets are distributed in the first direction V1 or the second direction V2.

The method of controlling the image forming system further includes an offset step for displacing a sheet S or a sheet bundle which is discharged to the discharge tray 23a or 23b in the first direction V1 or the second direction V2.

The method of controlling the image forming system further includes a mode selection step for selecting either the stacked sheet number priority mode or the stacking state priority mode.

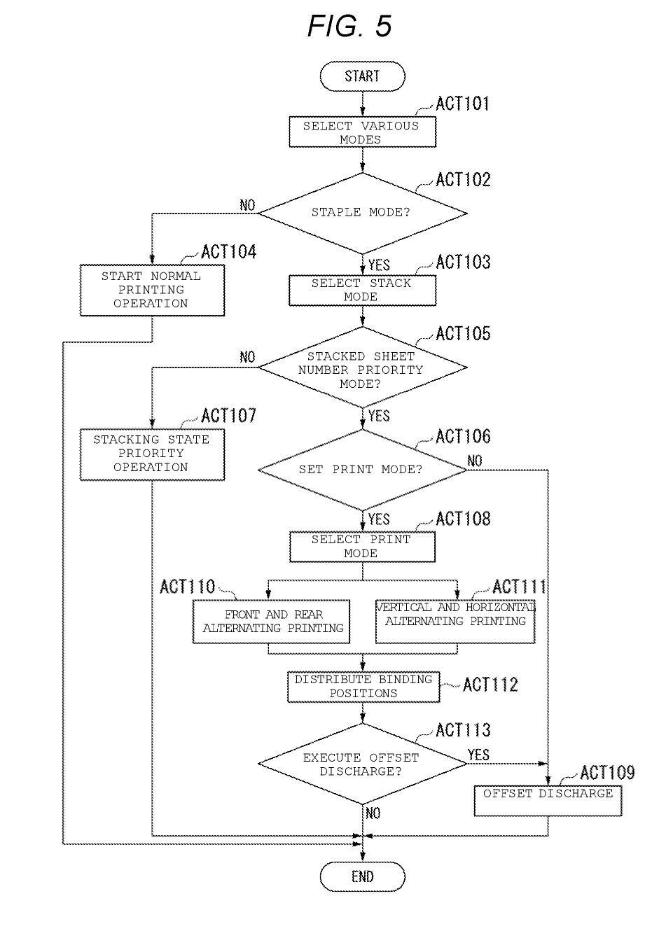

FIG. 5 is a flowchart illustrating an example sequence of operations of controlling the image forming system.

As illustrated in FIG. 5, first, various modes are selected (ACT101). For example, a user selects various modes by pushing various buttons of the mode selection unit 11a in the control panel 11.

Next, the control unit determines whether the “staple mode” is selected (ACT102). For example, the control unit determines whether the button selected by the user is a “staple” button. When the button selected by the user is the “staple” button, the control unit determines that the “staple mode” is selected (ACT102: YES), and advances the process to ACT103. When the button selected by the user is a “sort” button or a “non-sort” button, the control unit determines that the “staple mode” is not selected (ACT102: NO), and advances the process to ACT104.

In ACT104, the control unit starts a normal printing operation. That is, the binding unit 30 does not perform stapling of sheets S. The control unit terminates the process after the execution of the normal printing operation.

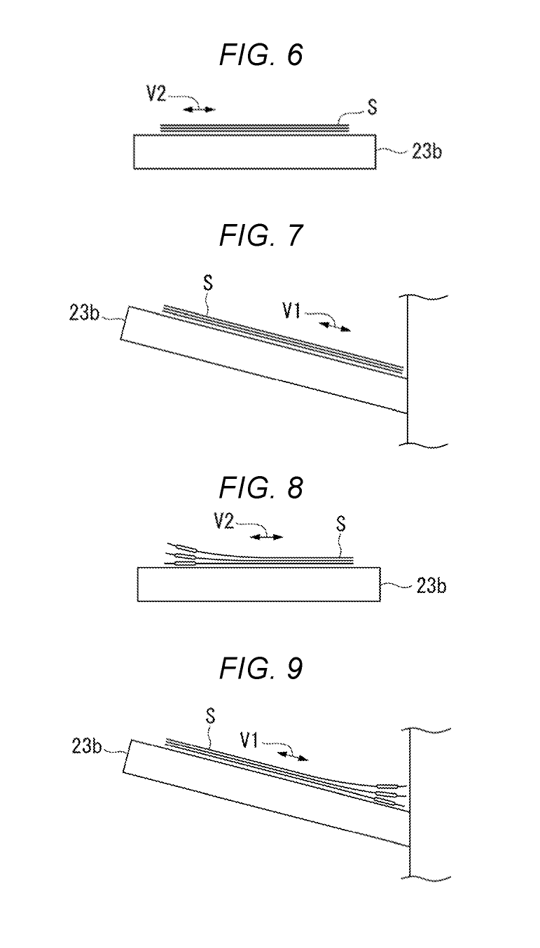

FIG. 6 is a front view illustrating a stacking state of sheets when the normal printing operation is performed. FIG. 6 illustrates a stacking state of sheets S discharged to the discharge tray 23b for the sake of convenience. The stacking state of sheets S discharged to the discharge tray 23a will be omitted in the drawings since it is similar to that in the discharge tray 23b. The omission in the drawing is also found in FIGS. 7 to 10, FIG. 14, FIG. 18, and FIG. 19. In the following drawings, one sheet S and one sheet bundle each will be shown by one line.

As illustrated in FIG. 6, a plurality of sheets S are stacked in order in the discharge tray 23b without being shifted in the second direction V2 when viewed from the front.

FIG. 7 is a side view illustrating a stacking state of sheets when the normal printing operation is performed.

As illustrated in FIG. 7, a plurality of sheets S are stacked in order in the discharge tray 23b without being shifted in the first direction V1 when viewed from the side.

Returning to FIG. 5, in ACT103, the stack mode is selected (mode selection step). For example, the user selects the stack mode by pushing various buttons of the mode selection unit 11a in the control panel 11.

Next, the control unit determines whether the “stacked sheet number priority mode” is selected (ACT105). For example, the control unit determines whether the button selected by the user is a “stacked sheet number priority” button. When the button selected by the user is the “stacked sheet number priority” button, the control unit determines that the “stacked sheet number priority mode” is selected (ACT105: YES), and advances the process to ACT106. When the button selected by the user is a “stacking state priority” button, the control unit determines that the “stacked sheet number priority mode” is not selected (ACT105: NO), and advances the process to ACT107.

In ACT107, the control unit allows a stacking state priority operation to be performed. That is, binding positions of a first sheet bundle S and a second sheet bundle S are in a fixed position without being distributed in the first direction V1 or the second direction V2. The control unit terminates the process after the execution of the stacking state priority operation.

FIG. 8 is a front view illustrating a stacking state of sheet bundles in the stacking state priority mode.

As illustrated in FIG. 8, a plurality of sheet bundles S are stacked in order in the discharge tray 23b without being shifted in the second direction V2 when viewed from the front. However, a part of the sheet bundle in the second direction V2 (that is, a stapled part) protrudes upward.

FIG. 9 is a side view illustrating a stacking state of sheet bundles in the stacking state priority mode.

As illustrated in FIG. 9, sheet bundles are stacked in order in the discharge tray 23b without being shifted in the first direction V1 when viewed from the side. However, a part of the sheet bundle in the first direction V1 (that is, the stapled part of each bundle) protrudes upward.

As described above, a the stapled part of the sheet bundle protrudes upward in the stacking state priority mode. Therefore, when too many sheet bundles are discharged to the discharge tray 23b and stacked, the stacked sheet bundles may collapse.

Returning to FIG. 5, in ACT106, the control unit determines whether to execute “print mode setting”. For example, the control unit determines whether the button selected by the user is a “print mode” button. When the button selected by the user is the “print mode” button, the control unit determines that the “print mode setting” is executed (ACT106: YES), and advances the process to ACT108. When the button selected by the user is an “offset” button, the control unit determines that the “print mode setting” is not executed (ACT106: NO), and advances the process to ACT109.

In ACT109, the control unit executes offset discharge. That is, the control unit controls the offset unit 40 to shift the sheet bundles which are discharged to the discharge tray 23a or 23b in the first direction V1 or the second direction V2 (offset step). A distance in which stapled parts do not overlap each other in the sheet bundle stacking direction is set as an offset quantity. Here, the “sheet bundle stacking direction” means a direction in which sheet bundles are stacked in the discharge tray 23b (that is, a direction of a normal line of an upper surface of the discharge tray 23b).

For example, the control unit controls the offset unit 40 to move the first slider 41 in the second direction V2, thereby displacing the sheet bundles in the second direction V2 (see FIG. 4). Otherwise, the control unit controls the offset unit 40 to move the second slider 42 in the first direction V1, thereby displacing the sheet bundles in the first direction V1 (see FIG. 4). The control unit terminates the process after the execution of the offset discharge.

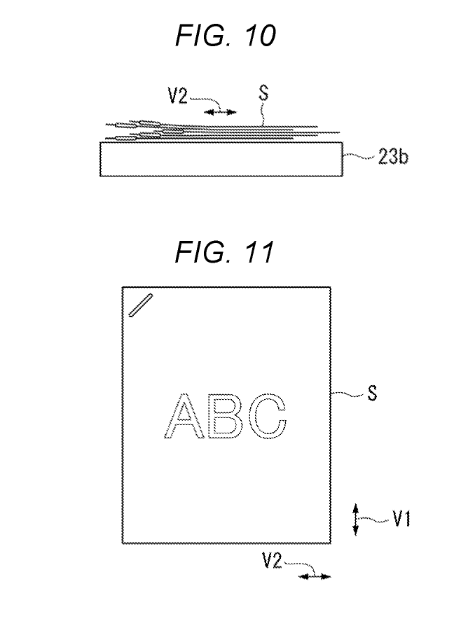

FIG. 10 is a front view illustrating a stacking state of sheet bundles when the offset discharge is performed.

As illustrated in FIG. 10, a plurality of sheet bundles are stacked while being shifted in the second direction V2 in the discharge tray 23b when viewed from the front. That is, binding positions related to the sheet bundles are in a fixed position, but the respective sheet bundles are shifted in the second direction V2. In other words, stapled parts do not overlap each other in the sheet bundle stacking direction.

Returning to FIG. 5, in ACT108, the control unit selects the print mode. For example, the print mode is previously stored in the ROM of the control unit as a control program for operation of the control unit. The ROM stores, as the print mode, either “front and rear alternating printing” or “vertical and horizontal alternating printing”.

When the print mode stored in the ROM is the “front and rear alternating printing”, the control unit executes a print mode of the “front and rear alternating printing” (image forming step, ACT110). That is, the control unit controls the printer unit 13 to alternately perform front-surface printing and rear-surface printing (image forming step). For example, the control unit controls the printer unit 13 to alternately perform a plurality of times of front-surface printing and a plurality of times of rear-surface printing. In the rear-surface printing, nothing is printed on the front surface at the time of simplex printing.

Next, in ACT112, the binding positions are distributed. That is, the control unit controls the binding unit 30 to distribute binding positions related to front-surface printed sheets and binding positions related to rear-surface printed sheets in the second direction V2 (distribution step). Hereinafter, the front-surface printed sheets stapled together will be referred to as “front-surface printed sheet bundle”, and the rear-surface printed sheets stapled together will be referred to as “rear-surface printed sheet bundle”.

FIG. 11 is a plan view of a front-surface printed sheet bundle in the front and rear alternating printing.

As illustrated in FIG. 11, in the distribution step, one corner part (hereinafter, referred to as “first corner part”) of the front-surface printed sheets in the second direction V2 is subjected to stapling. For example, the control unit controls the binding unit 30 to stop the stapler 31 in one third rail portion 32c of the guide rail 32, thereby subjecting the first corner part of the front-surface printed sheets to binding (see FIG. 3). Accordingly, a front-surface printed sheet bundle is obtained.

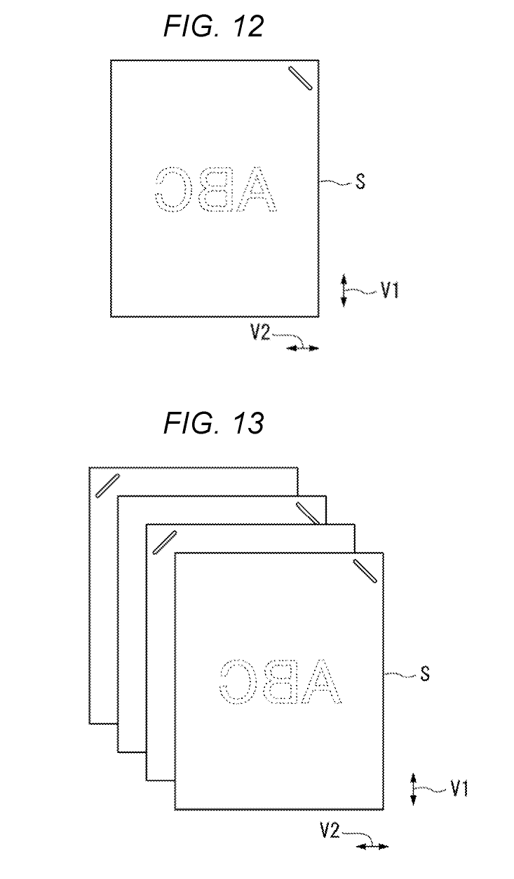

FIG. 12 is a plan view of a rear-surface printed sheet bundle in the front and rear alternating printing.

As illustrated in FIG. 12, in the distribution step, a corner part (hereinafter, referred to as “second corner part”), that is on an opposite side to the first corner part, of the rear-surface printed sheets in the second direction V2 is subjected to stapling. For example, the control unit controls the binding unit 30 to stop the stapler 31 in the other third rail portion 32c of the guide rail 32, thereby subjecting the second corner part of the rear-surface printed sheets to binding (see FIG. 3). Accordingly, a rear-surface printed sheet bundle is obtained.

In this manner, binding positions related to the front-surface printed sheet bundles and binding positions related to the rear-surface printed sheet bundles are distributed in the second direction V2.

FIG. 13 is a diagram illustrating a distribution state of the binding positions when the front and rear alternating printing is performed. In FIG. 13, for the sake of convenience, the respective sheet bundles are shifted in the first direction V1 and the second direction V2 such that the binding positions are shown.

As illustrated in FIG. 13, front-surface printed sheet bundles and rear-surface printed sheet bundles are alternately discharged such that the binding positions in the front-surface printed sheet bundles and the binding positions in the rear-surface printed sheets are distributed in the second direction V2.

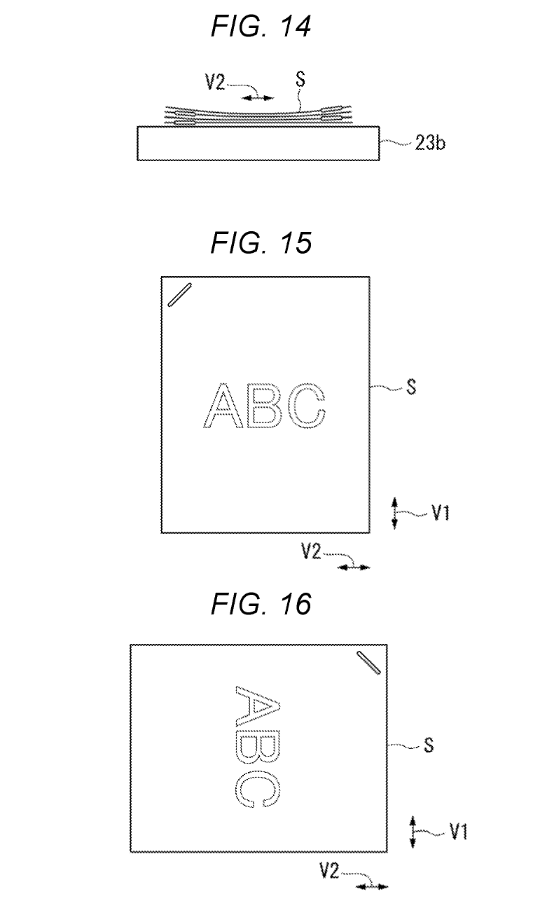

FIG. 14 is a front view illustrating a stacking state of the sheet bundles when the front and rear alternating printing is performed.

As illustrated in FIG. 14, the front-surface printed sheet bundles and the rear-surface printed sheet bundles are alternately stacked in the discharge tray 23b when viewed from the front. That is, the stapled parts are alternately shifted in the second direction V2 in the stacking direction of the sheet bundles. In other words, the stapled parts do not overlap each other continuously in the stacking direction of the sheet bundles.

The binding positions related to the front-surface printed sheet bundles and the binding positions related to the rear-surface printed sheet bundles may be distributed in the first direction V1. For example, in this case, the control unit controls the binding unit 30 to stop the stapler 31 at one end of the first rail portion 32a of the guide rail 32, thereby binding the front-surface printed sheets together (see FIG. 3). In addition, the control unit controls the binding unit 30 to stop the stapler 31 at the other end of the first rail portion 32a of the guide rail 32, thereby binding the rear-surface printed sheets together (see FIG. 3).

Returning to FIG. 5, when the print mode stored in the ROM is the “vertical and horizontal alternating printing”, the control unit executes a print mode of the “vertical and horizontal alternating printing” (image forming step, ACT111). That is, the control unit controls the paper feeding unit 14 to alternately supply vertical printed sheets and horizontal printed sheets (supply step). For example, the control unit controls the paper feeding unit 14 to alternately supply a plurality of vertical printed sheets and a plurality of horizontal printed sheets. The control unit sets vertical sheets having a longer side in the first direction as a type of medium stored in the first medium storage unit in advance. As well, the control unit sets horizontal sheets having a shorter side in the first direction as a type of medium stored in the second medium storage unit in advance.

Next, in ACT 112, the binding positions are distributed. That is, the control unit controls the binding unit 30 to distribute binding positions related to vertical printed sheets and binding positions related to horizontal printed sheets in the second direction V2 (distribution step). Hereinafter, the vertical printed sheets stapled together will be referred to as “vertical printed sheet bundle”, and the horizontal printed sheets stapled together will be referred to as “horizontal printed sheet bundle”.

FIG. 15 is a plan view of a vertical printed sheet bundle in the vertical and horizontal alternating printing.

As illustrated in FIG. 15, in the distribution step, a first corner part of the vertical printed sheets in the second direction V2 is subjected to stapling. For example, the control unit controls the binding unit 30 to stop the stapler 31 in one third rail portion 32c of the guide rail 32, thereby subjecting the first corner part of the vertical printed sheets to binding (see FIG. 3). Accordingly, a vertical printed sheet bundle is obtained.

FIG. 16 is a plan view of a horizontal printed sheet bundle in the vertical and horizontal alternating printing.

As illustrated in FIG. 16, in the distribution step, a second corner part of the horizontal printed sheets in the second direction V2 is subjected to stapling. For example, the control unit controls the binding unit 30 to stop the stapler 31 in the other third rail portion 32c of the guide rail 32, thereby subjecting the second corner part of the horizontal printed sheets to binding (see FIG. 3). Accordingly, a horizontal printed sheet bundle is obtained.

In this manner, binding positions related to the vertical printed sheet bundles and fastening positions related to the horizontal printed sheet bundles are distributed in the second direction V2.

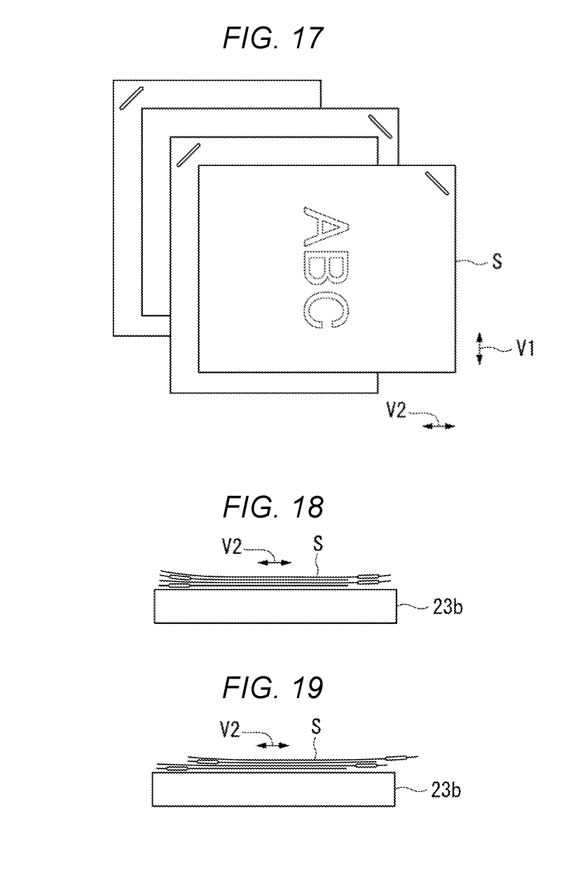

FIG. 17 is a diagram illustrating a distribution state of the binding positions when the vertical and horizontal alternating printing is performed. In FIG. 17, the respective sheet bundles are shifted in the first direction V1 and the second direction V2 such that the binding positions are shown.

As illustrated in FIG. 17, vertical printed sheet bundles and horizontal printed sheet bundles are alternately discharged such that the binding positions in the vertical printed sheet bundles and the binding positions in the horizontal printed sheet bundles are distributed in the second direction V2.

FIG. 18 is a front view illustrating a stacking state of the sheet bundles when the vertical and horizontal alternating printing is performed.

As illustrated in FIG. 18, the vertical printed sheet bundles and the horizontal printed sheet bundles are alternately stacked in the discharge tray 23b when viewed from the front. That is, the stapled parts are alternately shifted in the second direction V2 in the stacking direction of the sheet bundles. In addition, one ends of the vertical printed sheet bundles and the horizontal printed sheet bundles are arranged on one side in the second direction V2. On one side in the second direction V2, the stapled parts do not overlap each other continuously in the stacking direction of the sheet bundles. The other ends of the horizontal printed sheet bundles protrude sideways more than the vertical printed sheet bundles on the other side in the second direction V2. On the other side in the second direction V2, the stapled parts overlap each other continuously in the stacking direction of the sheet bundles.

The binding positions related to the vertical printed sheet bundles and the binding positions related to the horizontal printed sheet bundles may be distributed in the first direction V1. For example, in this case, the control unit controls the binding unit 30 to stop the stapler 31 at one end of the first rail portion 32a of the guide rail 32, thereby binding the vertical printed sheets together (see FIG. 3). In addition, the control unit controls the binding unit 30 to stop the stapler 31 at the other end of the first rail portion 32a of the guide rail 32, thereby binding the horizontal printed sheets together (see FIG. 3).

Returning to FIG. 5, in ACT113, the control unit determines whether the “offset discharge” is executed. For example, the setting of the “offset discharge” is previously stored in the ROM of the control unit as a control program for operation of the control unit. The ROM stores the setting of whether to execute the “offset discharge”.

When the setting of the execution of the “offset discharge” is stored in the ROM (ACT113: YES), the control unit advances the process to ACT109. When the execution of the “offset discharge” is not stored in the ROM (ACT113: NO), the control unit terminates the process.

In ACT109, the control unit executes the “offset discharge”. That is, the control unit shifts the sheet bundles which are discharged to the discharge tray 23a or 23b in the first direction V1 or the second direction V2 (offset step). The control unit terminates the process after the execution of the vertical and horizontal alternating printing and the offset discharge.

FIG. 19 is a front view illustrating a stacking state of the sheet bundles when the vertical and horizontal alternating printing and the offset discharge are executed in combination.

As illustrated in FIG. 19, vertical printed sheet bundles and horizontal printed sheet bundles are alternately stacked in the discharge tray 23b when viewed from the front. In addition, the vertical printed sheet bundles and the horizontal printed sheet bundles are stacked while being shifted in the second direction V2. That is, the stapled parts are alternately shifted in the second direction V2 in the stacking direction of the sheets S. In addition, the stapled parts do not overlap each other in the stacking direction of the sheets S.

The control unit is not limited to the execution of the vertical and horizontal alternating printing and the offset discharge in combination. For example, the control unit may execute the front and rear alternating printing and the offset discharge in combination.

When sheet bundles are continuously discharged to the discharge tray and stacked, stapled parts may protrude. Therefore, the stacked sheet bundles may collapse. Particularly, when a sleep operation is performed to realize power saving, the probability of collapse of the stacked sheet bundles is increased. Therefore, it is necessary to set the full load condition of the sheets in the discharge tray to such a number of sheets that the stacked sheet bundles do not collapse.

The reason for this will be described as follows. The post-processing apparatus includes a detection unit which detects sheet stack information of in the discharge tray. For example, the detection unit includes three sensors (first sensor, second sensor, and third sensor). The first sensor detects the presence or absence of a sheet on the paper discharge tray. The second sensor detects the lower limit position of the paper discharge tray. The third sensor detects the stacking height of the sheets on the paper discharge tray. For example, the third sensor detects a specific location such as a center portion of the paper discharge tray. Otherwise, the third sensor detects the highest position of the stacked sheets using a lever. Based on the detection result of the detection unit, the discharge tray can be lowered to a certain height position. The post-processing apparatus includes a storage unit which stores sheet stack information of the discharge tray. For example, the storage unit is a non-volatile memory such as an EEPROM. The storage unit has a smaller number of times of rewriting and a smaller memory capacity than a storage device such as a HDD in a MFP. In general, when a sleep operation is performed (during standby of MFP), the power source of the post-processing apparatus is turned off for low power consumption. During the period of time in which the power source of the post-processing apparatus is turned off, the sheet stack information is not clear since it is not detected. In addition, after the power source of the post-processing apparatus after the sleep operation is turned on, (hereinafter, referred to as “after sleep restoration”), the sheet stack information of the discharge tray becomes known. Therefore, the detection unit determines the full load in a state in which there is no information about the sheets stacked in the discharge tray. As a result, even when the discharge tray has a loading capacity, it is necessary to quickly determine that the tray is fully loaded when there are sheets thereon, or it is necessary to set the full load condition to a minimum number of sheets after the sleep restoration. That is, it is necessary to set the full load condition of the sheets in the discharge tray to such a number of sheets that the stacked sheet bundles do not collapse.

In order to avoid this, the post-processing apparatus may be provided with a HDD which is similar to that of an MFP or a memory backed up by a battery. However, an expensive storage device is provided depending only on the determination of full load after the sleep restoration. The system may be notified of the stack information of the post-processing apparatus, and may store and manage the sheet stack information of the discharge tray even during the sleep operation. However, the system should always continuously manage the stack information of the post processing apparatus that is unrelated to the operation of the system.

According to the first embodiment, the image forming system 1 includes the printer unit 13, the binding unit 30, and the control unit. The printer unit 13 forms an image on a sheet S. The binding unit 30 staples the sheets S each having the image formed thereon together. The control unit controls the printer unit 13 and the binding unit 30 such that binding positions related to a first sheet S and a second sheet S are distributed in the first direction V1 or the second direction V2. By virtue of the configuration, the following effects are achieved. By distributing the binding positions related to the first sheet S and the second sheet S in the first direction V1 or the second direction V2, the sheet bundles are continuously discharged to the discharge tray 23a or 23b, and it is possible to suppress protrusion of the stapled parts even when the sheet bundles are stacked. Accordingly, collapse of the stacked sheet bundles can be suppressed. In addition, power saving associated with the sleep operation of the MFP can be realized. In addition, since it is not necessary to provide an expensive storage device in the post-processing apparatus, the cost can be reduced. In addition, it is also not necessary for the system to manage the stack information of the post-processing apparatus.

The control unit controls the printer unit 13 such that the front-surface printing and the rear-surface printing are alternately performed. In addition, the control unit controls the binding unit 30 such that binding positions related to front-surface printed sheets and binding positions related to rear-surface printed sheets are distributed in the second direction V2. By virtue of the configuration, the following effects are achieved. Stapled parts are alternately shifted in the first direction V1 or the second direction V2 in the stacking direction of the sheet bundles. Therefore, it is possible to avoid continuous overlap of the stapled parts in the stacking direction of the sheet bundles in the front-surface printed sheet bundles and the rear-surface printed sheet bundles. Accordingly, it is possible to more securely suppress collapse of the stacked sheet bundles.

The control unit controls the paper feeding unit 14 such that vertical printed sheets and horizontal printed sheets are alternately supplied. In addition, the control unit controls the binding unit 30 such that binding positions related to vertical printed sheets and binding positions related to horizontal printed sheets are distributed in the first direction V1 or the second direction V2. By virtue of the configuration, the following effects are achieved. In the stacking direction of the sheet bundles, stapled parts are alternately shifted in the first direction V1 or the second direction V2. Therefore, it is possible to partially avoid continuous overlap of the stapled parts in the stacking direction of the sheet bundles in the vertical printed sheet bundles and the horizontal printed sheet bundles. Accordingly, it is possible to more securely suppress collapse of the stacked sheet bundles.

The following effects are achieved when the image forming system 1 is further provided with the offset unit 40 which shifts sheets S which are discharged to the discharge tray 23a or 23b in the first direction V1 or the second direction V2. Since the respective sheet bundles are shifted in the first direction V1 or the second direction V2, it is possible to avoid overlap of the stapled parts in the stacking direction of the sheet bundles in the sheet bundles. Accordingly, it is possible to simply suppress collapse of the sheet bundles. In addition, when the vertical and horizontal alternating printing and the offset discharge are executed in combination, it is more securely suppress collapse of the sheet bundles along with the effect of distributing the binding positions by the vertical and horizontal alternating printing. When the front and rear alternating printing and the offset discharge are executed in combination, it is also more securely suppress collapse of the sheet bundles along with the effect of distributing the binding positions by the front and rear alternating printing. Particularly, the above-described execution in combination is actually advantageous when the thickness of the stapled part is smaller than the thickness of the sheet part in the sheet bundles.

The following effects are achieved when the image forming system 1 is further provided with the mode selection unit 11a allowing a user to select the stacked sheet number priority mode and the stacking state priority mode. The stack mode of the discharge tray 23a or 23b can be selected according to a user's request.

The method of controlling the image forming system includes the image forming step, the binding step, and the distribution step. In the image forming step, an image is formed on a sheet S. In the binding step, the sheets S each having an image formed thereon are bound together. In the distribution step, binding positions related to a first sheet S and a second sheet S are distributed in the first direction V1 or the second direction V2. By virtue of the steps, the following effects are achieved. By distributing the binding positions related to the first sheet S and the second sheet S in the first direction V1 or the second direction V2, the sheet bundles are continuously discharged to the discharge tray 23a or 23b, and it is possible to suppress protrusion of the stapled parts even when the sheet bundles are stacked. Accordingly, collapse of the stacked sheet bundles can be suppressed. In addition, power saving associated with the sleep operation of the MFP can be realized. In addition, since it is not necessary to provide an expensive storage device in the post-processing apparatus, the cost can be reduced. In addition, it is also not necessary for the system to manage the stack information of the post-processing apparatus.

In the image forming step, the front-surface printing and the rear-surface printing are alternately performed. In the binding step, binding positions related to front-surface printed sheets and binding positions related to rear-surface printed sheets are distributed in the first direction V1 or the second direction V2. By virtue of the steps, the following effects are achieved. In the stacking direction of the sheet bundles, the stapled parts are alternately shifted in the first direction V1 or the second direction V2. Therefore, it is possible to avoid continuous overlap of the stapled parts in the stacking direction of the sheet bundles in the front-surface printed sheet bundles and the rear-surface printed sheet bundles. Accordingly, it is possible to more securely suppress collapse of the stacked sheet bundles.

The method of controlling the image forming system further includes the supply step for supplying vertical printed sheets and horizontal printed sheets. In the supply step, the vertical printed sheets and the horizontal printed sheets are alternately supplied. In the distribution step, binding positions related to the vertical printed sheets and binding positions related to the horizontal printed sheets are distributed in the first direction V1 or the second direction V2. By virtue of the steps, the following effects are achieved. In the stacking direction of the sheet bundles, the stapled parts are alternately shifted in the first direction V1 or the second direction V2. Therefore, it is possible to partially avoid continuous overlap of the stapled parts in the stacking direction of the sheet bundles in the vertical printed sheet bundles and the horizontal printed sheet bundles. Accordingly, it is possible to more securely suppress collapse of the stacked sheet bundles.

The following effects are achieved when the method of controlling the image forming system further includes the offset step for displacing sheets S which are discharged to the discharge tray 23a or 23b in the first direction V1 or the second direction V2. Since the respective sheet bundles are shifted in the first direction V1 or the second direction V2, it is possible to avoid overlap of the stapled parts in the stacking direction of the sheet bundles in the sheet bundles. Accordingly, it is possible to simply suppress collapse of the sheet bundles. In addition, when the vertical and horizontal alternating printing and the offset discharge are executed in combination, it is more securely suppress collapse of the sheet bundles along with the effect of distributing the binding positions by the vertical and horizontal alternating printing. When the front and rear alternating printing and the offset discharge are executed in combination, it is also more securely suppress collapse of the sheet bundles along with the effect of distributing the binding positions by the front and rear alternating printing. Particularly, the above-described execution in combination is actually advantageous when the thickness of the stapled part is smaller than the thickness of the sheet part in the sheet bundles.

The following effects are achieved when the method of controlling the image forming system further includes the mode selection step for selecting either the stacked sheet number priority mode or the stacking state priority mode. The stack mode of the discharge tray 23a or 23b can be selected according to a user's request.

Embodiments are not limited to the configuration in which the control unit controls the printer unit 13 such that the front-surface printing and the rear-surface printing are alternately performed. For example, the post-processing apparatus 3 may be provided with a reversing device capable of reversing the front and rear surfaces of a sheet S.

### Second Embodiment

Hereinafter, the image forming system of a second embodiment will be described with reference to the drawings. The second embodiment is a modification of the first embodiment. In the following description of the second embodiment, components having functions same as those explained in the first embodiment are denoted by the same reference numerals and signs, and explanation of such components is repeated as needed.

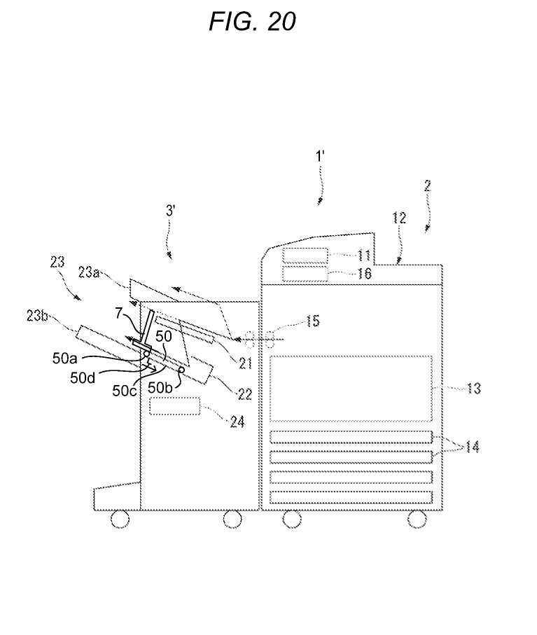

FIG. 20 is a schematic diagram illustrating an example configuration of an image forming system 1′ according to the second embodiment. In addition to the components of the image forming system 1, the image forming system 1′ of the second embodiment further includes a reversing unit 7.

In the image forming system 1′ according to the second embodiment, the reversing unit 7 is disposed at a position between the stacking unit 50 and the discharge tray 23b. The reversing unit 7 is configured to receive the sheet bundle which is conveyed from the stacking unit 50.

The reversing unit 7 discharges the received sheet bundle onto the discharge tray 23b after handling the received sheet bundle in one of two operations modes. The reversing unit 7 conveys the sheet bundle in a first operation mode for reversing the sheet bundle and then discharging the reversed sheet bundle onto the discharge tray 23b or a second operation mode for conveying the sheet bundle without reversing the sheet bundle and discharging the sheet bundle onto the discharge tray 23b.

The stacking unit 50 includes a drive roller 50a, a driven roller 50b, an endless belt 50c, and a hook 50d. The endless belt 50c is wrapped around the drive roller 50a and the driven roller 50b. The drive roller 50a is driven by a motor (not illustrated) under the control of the post-processing control unit 24. The hook 50d is protruded from an outer circumferential surface of the endless belt 50c and moves with the endless belt 50c. That is, when the drive roller 50a is driven, the endless belt 50c and the driven roller 50b are simultaneously rotated, and then, the hook 50d moves around the endless belt 50c together with the outer circumferential surface of the endless belt 50c. According to the above configuration of the stacking unit 50, the hook 50d can push the rear end of the sheet bundle S and feed the sheet bundle S, which is stapled by the stapler 31, toward the discharge tray 23b.

The printer unit 13 of the image forming system 1′ can perform each of the front-surface printing and the rear-surface printing and a combination of the front-surface printing and the rear-surface printing just as in the image forming system 1 according to the first embodiment.

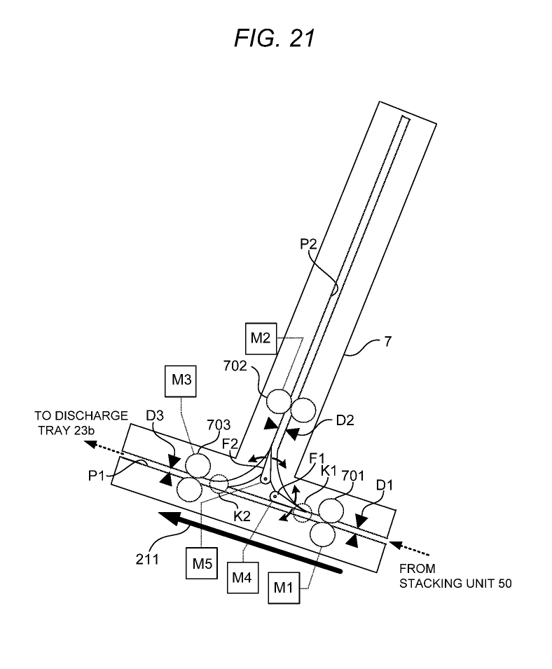

FIG. 21 is a schematic diagram illustrating an example configuration of the reversing unit 7 according to the second embodiment. As shown in FIG. 21, the reversing unit 7 includes sheet guides P1 and P2, roller pairs 701-703, flappers F1 and F2, motors M1-M5, and sensors D1-D3.

The sheet guide P1 is a sheet conveying guide which forms a first sheet conveying path from the downstream end of the stacking unit 50 toward the discharge tray 23b. The sheet guide P1 extends in a conveying direction 211 shown in FIG. 21.

The sheet guide P2 is a switchback conveyance guide, which forms a second sheet conveying path that is branched from the first conveying path at a branch point K1. The second sheet conveying path also merges with the first sheet conveying path at a conveying point K2, which is on a downstream side of the branch point K1.

The roller pair 701 and roller pair 703 are arranged in the first sheet conveying direction. The roller pair 701 is disposed on upstream side of the branch point K1. The roller pair 703 is disposed on downstream side of the converging point K2. The roller pair 701 and roller pair 703 convey a sheet or sheet bundle along the first sheet conveying path when they are rotated by the motors M1 and M3.

The roller pair 702 is disposed along the sheet guide P2. The roller pair 702 conveys a sheet or sheet bundle along the second sheet conveying path when they are rotated by the motor M2.

The flapper F1 is disposed at the branch point K1 and is rotatable to switch a conveying path of the sheet bundle between the first conveying path and second conveying path. Control of the movement of the flapper F1 is explained later.

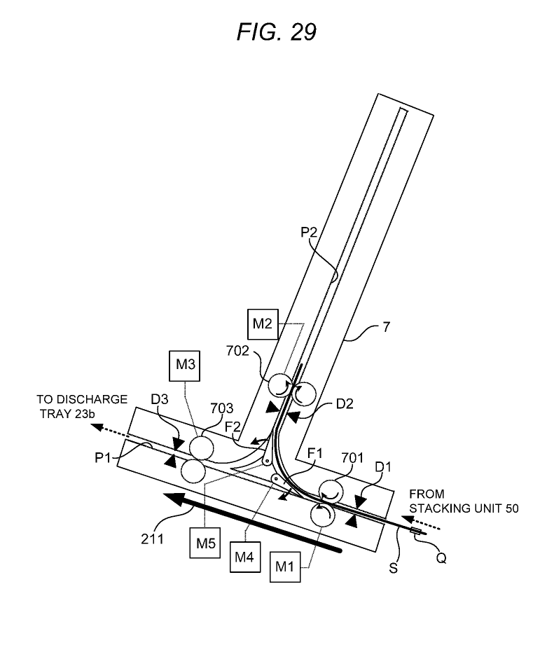

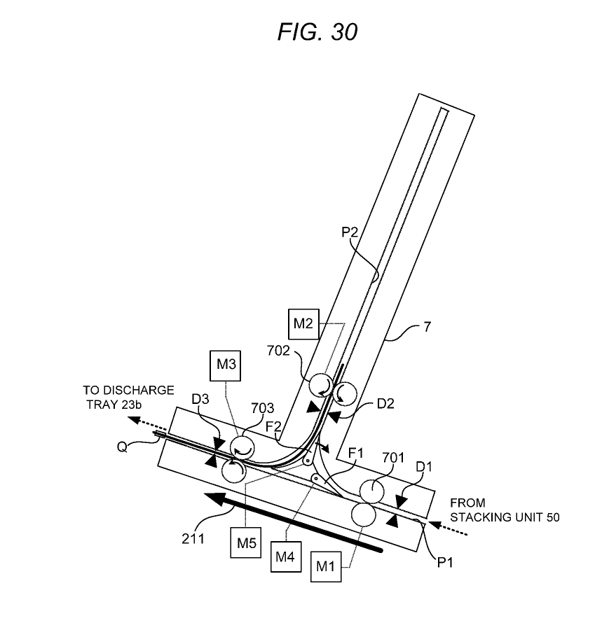

The flapper F2 is disposed at a point between the branch point K1 and the converging point K2. When the flapper F2 is at a first angular position shown in FIG. 29, the flapper F2 allows the sheet bundle to enter into the second sheet conveying path from the first sheet conveying path. When the flapper F2 is at a second angular position shown in FIG. 30, the flapper F2 allows the sheet bundle to enter into the first sheet conveying path from the second sheet conveying path. Control of the movement of the flapper F2 is explained later.

The motor M1 supplies a rotational force to the roller pair 701 directly or indirectly through a power transmission mechanism such as a gear train (not illustrated).

The motor M2 supplies a rotational force to the roller pair 702 directly or indirectly through a power transmission mechanism such as a gear train (not illustrated).

The motor M3 supplies a rotational force to the roller pair 703 directly or indirectly through a power transmission mechanism such as a gear train (not illustrated). In an alternative embodiment, the roller pairs 701 and 703 may be driven by the same motor.

The motor M4 supplies a rotational force to the flapper F1 directly or indirectly through a power transmission mechanism such as a gear train (not illustrated).

The motor M5 supplies a rotational force to the flapper F2 directly or indirectly through a power transmission mechanism such as a gear train (not illustrated).

The sensor D1 is disposed on an upstream side of the roller pair 701 along the first sheet conveying path. The sensor D1 is, for example, a transmittance detection sensor, a reflective sensor, or a mechanical sensor that is a combination of an optical sensor and a mechanical lever.

The sensor D2 is disposed at a point between the roller pair 702 and the flapper F2 along the second sheet conveying path. The sensor D2 is, for example, a transmittance detection sensor, a reflective sensor, or a mechanical sensor which is a combination of an optical sensor and a mechanical lever.

The sensor D3 is disposed on downstream side of the roller pair 703 along the first sheet conveying path. The sensor D3 is, for example, a transmittance detection sensor, a reflective sensor, or a mechanical sensor that is a combination of an optical sensor and a mechanical lever.

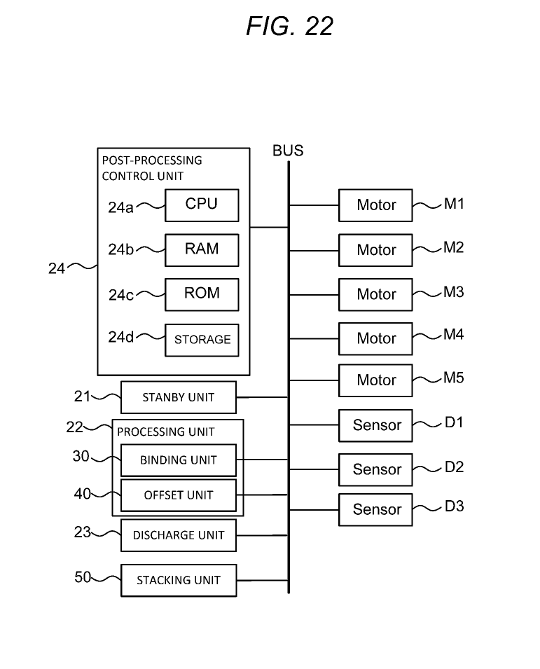

FIG. 22 is a schematic block diagram illustrating an example configuration of functional blocks of the post-processing apparatus according to the second embodiment. As shown in FIG. 22, motors M1-M5 and sensors D1-D3 are further included in the image forming apparatus 1′ when compared to image forming apparatus 1. The post-processing control unit 24, the standby unit 21, the processing unit 22, the discharge unit 23, the stacking unit 50, motors M1-M5 and sensors D1-D3 are electrically connected each other via a BUS line. Specifically, the post-processing control unit 24 includes a control circuit including a CPU 24a, a RAM 24b, a ROM 24c, and storage 24d. The CPU 24a realizes functions of the post-processing control unit 24 by executing programs stored in the ROM 24c or the storage 24d.

In the second embodiment, the image forming system 1′ performs the stapling process according to discharge modes 1-4. The user can select either a normal discharge mode or a mixed discharge mode through the control panel 11. The normal discharge mode has a stored setting that specifies one of discharge modes 1-4 (e.g., discharge mode 1) and the mixed discharge mode has a stored setting that specifies a combination of the discharge modes 1-4 (e.g., discharge modes 1-4 executed in order. The mixed discharge mode is selected to avoid overlap of stapled positions of two adjacent sheet bundles.

The user can change the one discharge mode specified by the normal discharge mode and the combination of discharge modes specified by the mixed discharge mode through the control panel 11. The setting information of the normal discharge mode and the mixed discharge mode and the user selection between the normal discharge mode and the mixed discharge mode are stored in the storage 24d. The CPU 24a acquires the setting information from the storage 24d.

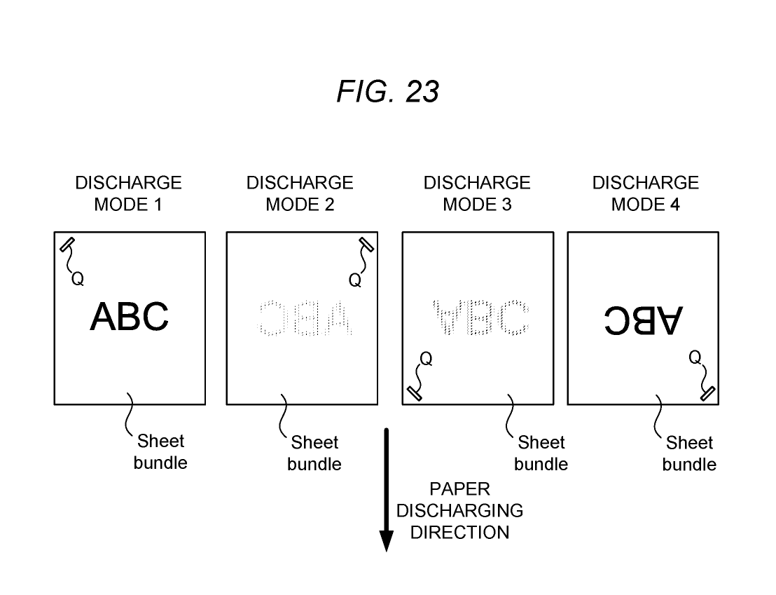

FIG. 23 is a conceptual plane view illustrating output results of each of the discharge modes 1-4.

In the discharge mode 1, the image forming system 1′ discharges the bound sheet bundle such that the stapled part is positioned at the near right side of the sheet bundle when viewed from the image forming apparatus 2 toward the discharge tray 23b (shown as top left side in FIG. 23).

In the discharge mode 2, the image forming system 1′ discharges the bound sheet bundle such that the stapled part is positioned at the near left side of the sheet bundle when viewed from the image forming apparatus 2 toward the discharge tray 23b (shown as top right side in FIG. 23).

In the discharge mode 3, the image forming system 1′ discharges the bound sheet bundle such that the stapled part is positioned at the far right side of the sheet bundle when viewed from the image forming apparatus 2 toward the discharge tray 23b (shown as bottom left side in FIG. 23).

In the discharge mode 4, the image forming system 1′ discharges the bound sheet bundle such that the stapled part is positioned at the far left side of the sheet bundle when viewed from the image forming apparatus 2 toward the discharge tray 23b (shown as bottom right side in FIG. 23).

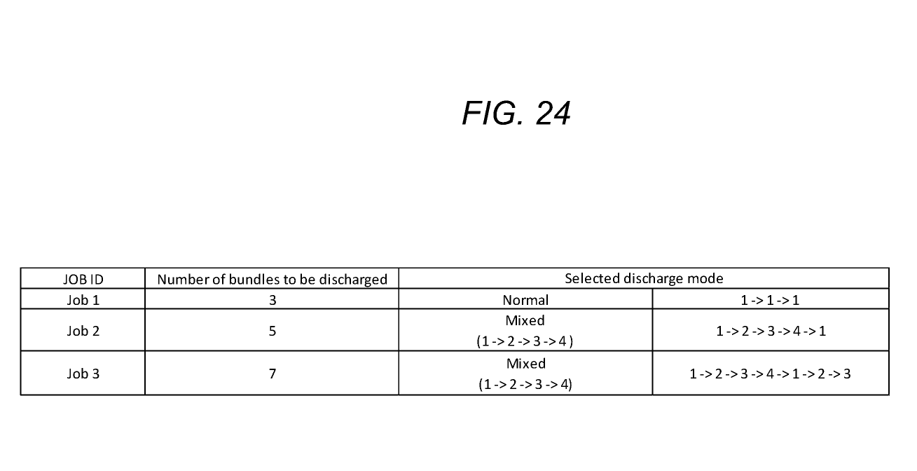

FIG. 24 is a table showing an example of different jobs and the discharge mode selected for each of the different jobs.

In this example, the image forming system 1′ executes three print jobs including the stapling process. They are Job 1, Job 2 and Job 3. Job 1 performs one-sided printing and stapling of three bundles, Job 2 performs one-sided printing and stapling of five bundles, and Job 3 performs one-sided printing and stapling of seven bundles. In addition, the user selects the normal discharge mode for Job 1, and the mixed discharge mode for Job 2 and Job 3. In the case of Job 1, the image forming system 1′ staples three bundles and discharges the three bundles in the normal discharge mode, which is set as discharge mode 1. On the other hand, in the case of Job 3, the image forming system 1′ staples seven bundles and discharges the seven bundles in the mixed discharge mode which is set as discharge modes 1-4 executed in order and then discharge modes 1-3 executed in order. That is, a first sheet bundle is discharged in the discharge mode 1. A second sheet bundle is discharged in the discharge mode 2. A third sheet bundle is discharged in the discharge mode 3. A fourth sheet bundle is discharged in the discharge mode 4. A fifth sheet bundle is discharged in the discharge mode 1. A sixth sheet bundle is discharged in the discharge mode 2. A seventh sheet bundle is discharged in the discharge mode 3.

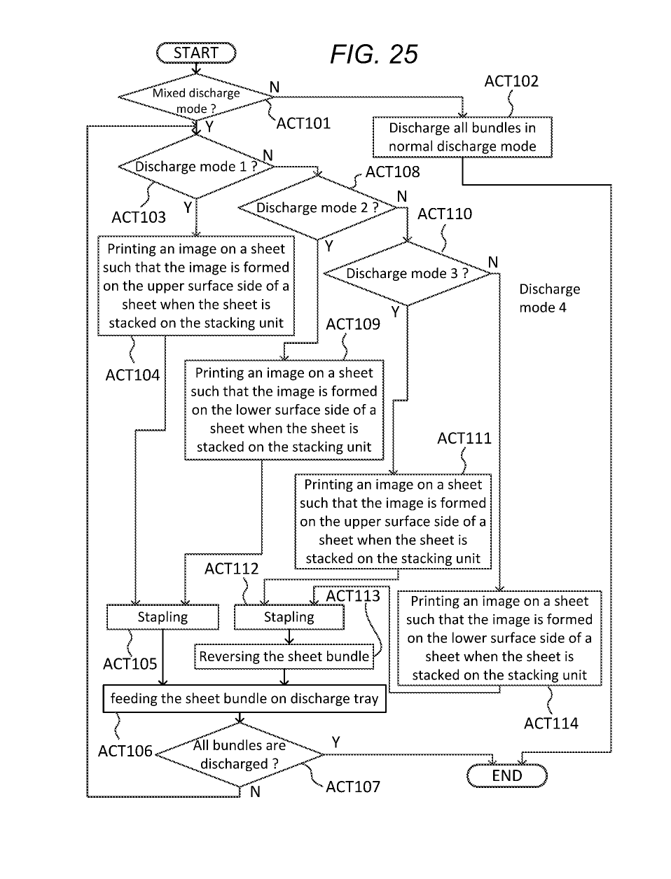

FIG. 25 is a flow chart of a post-processing operation according to the second embodiment.

First, in a case where the CPU 24a receives an instruction to perform printing on sheets and staple the bundle of sheets on which images are formed, the CPU 24a acquires the setting information about the discharge mode, which is stored in the storage 24d.

The CPU 24a generates a job to perform the printing and discharging of the bundle in the discharge mode selected by the user based on the acquired information. If the setting information stored in the storage 24d indicates that sheet bundles to be printed out should be discharged in the normal discharge mode (ACT 101, No), the CPU 24a performs the normal discharge mode (ACT 102). That is, the CPU 24a performs the sheet discharging process in the discharge mode 1 for all of sheet bundles to be discharged.

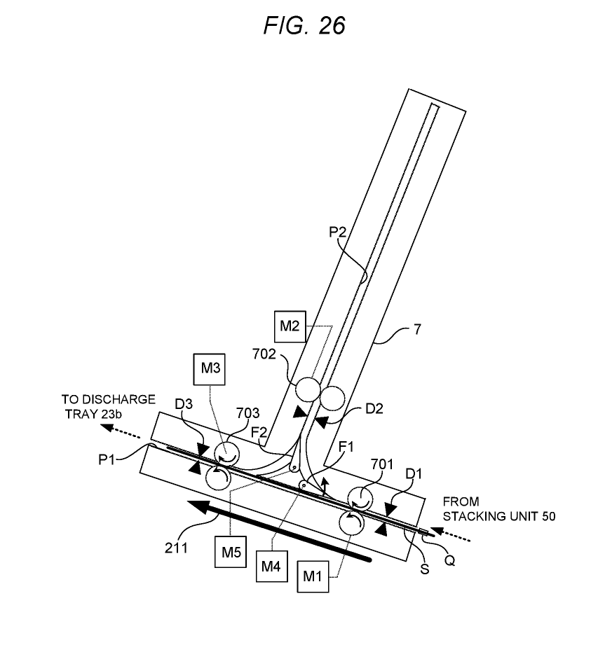

FIG. 26 shows the conveying operation of the sheet bundle in the normal discharge mode by the reversing unit 7. As shown in FIG. 26, in the normal discharge mode, the CPU 24a controls motor M4 to rotate the flapper F1 (i.e., in the counter-clockwise direction in the example depicted in FIG. 26) when the sensor D1 detects the front end of the sheet bundle to allow the sheet bundle which is fed by the stacking unit 50 to pass through the sheet guide P1. The sheet bundle S is discharged onto the discharge tray 23b by the roller pair 703 after passing through the sheet guide P1.

On the other hand, if the setting information stored in the storage 24d indicates that sheet bundles to be printed out should be discharged in the mixed discharge mode (ACT 101, Yes), the CPU 24a performs the mixed discharge mode. The CPU 24a determines from the setting information which discharge mode should be applied to each sheet bundle. For example, in the case of Job 2 shown in FIG. 24, the CPU 24a determines the discharge mode for the first sheet bundle as discharge mode 1 (ACT 103, Yes). Next, the CPU 24a causes the image forming apparatus 2 to print an image on a sheet such that the image is formed on the upper surface side of a sheet when the sheet is stacked on the stacking unit (ACT 104), and causes the post-processing apparatus 3 to perform the stapling process (ACT 105) to staple the near right side of the sheet bundle, and then, causes the reversing unit 7 to convey and discharge the first sheet bundle to the discharge tray 23d (ACT 106).

Next, the CPU 24a determines in ACT 107 whether all sheet bundles have been discharged. In the example of Job 2, there are 4 additional sheet bundles to be discharged, so the CPU 24a returns to ACT 103 (No) and then to ACT 108 (Yes) to determine that the second sheet bundle of Job 2 should be discharged in the discharge mode 2. Next, the CPU 24a causes the image forming apparatus 2 to print an image on a sheet such that the image is formed on the lower surface side of a sheet when the sheet is stacked on the stacking unit (ACT 109), causes the post-processing apparatus 3 to perform the stapling process (ACT 105) to staple the near left side of the sheet bundle, and then, causes the reversing unit 7 to convey and discharge the second sheet bundle to the discharge tray 23d (ACT 106).

Subsequently, the CPU 24a determines that all sheet bundles have not yet been discharged (ACT 107, NO) and returns to ACT 103 (No) and then to ACT 108 (No) and ACT 110 to determine that the third sheet bundle should be discharged in the discharge mode 3. Next, the CPU 24a causes the image forming apparatus 2 to print an image on a sheet such that the image is formed on the upper surface side of a sheet when the sheet is stacked on the stacking unit (ACT 111), causes the post-processing apparatus 3 to perform the stapling process (ACT 112) to staple the far right side of the sheet bundle, and then, causes the reversing unit 7 to reverse the third sheet bundle (ACT 113) and discharge the third sheet bundle to the discharge tray 23d (ACT 106).

Then, the CPU 24a determines that all sheet bundles have not yet been discharged (ACT 107, NO) and returns to ACT 103 (No) and then to ACT 108 (No) and ACT 110 (No) to determine that the third sheet bundle should be discharged in the discharge mode 4. Next, the CPU 24a causes the image forming apparatus 2 to print an image on a sheet such that the image is formed on the lower surface side of a sheet when the sheet is stacked on the stacking unit (ACT 114), causes the post-processing apparatus 3 to perform the stapling process (ACT 112) to staple the far left side of the sheet bundle, and then, causes the reversing unit 7 to reverse the third sheet bundle (ACT 113) and discharge the third sheet bundle to the discharge tray 23d (ACT 106).

The CPU 24a ends the operation if all sheet bundles are discharged (ACT 107, Yes).

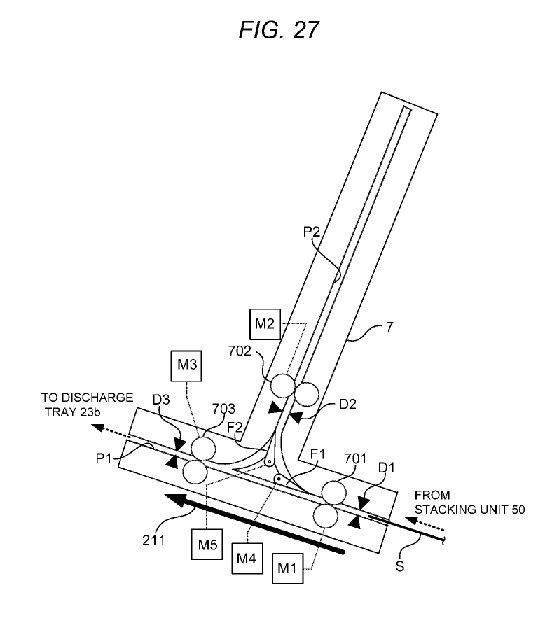

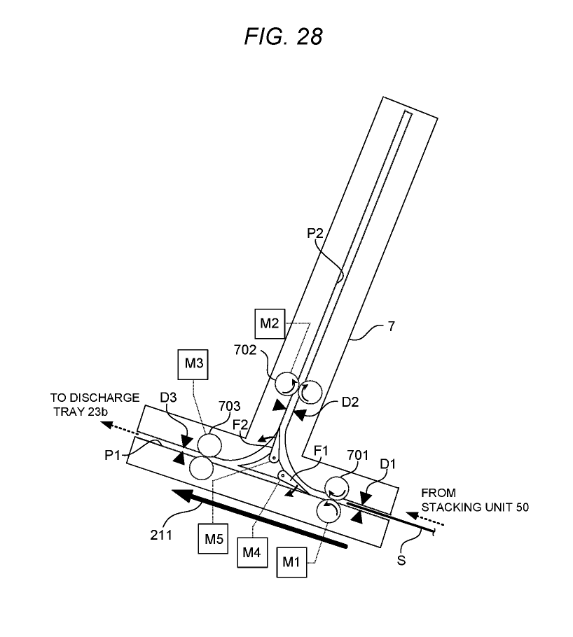

FIGS. 27-30 are schematic diagrams illustrating a movement of the each elements of the reversing unit 7 when the reversing operation is performed. When the reversing unit 7 receives the sheet bundle S which is fed from the stacking unit 50 (FIG. 27), the sensor D1 of the reversing unit 7 detects the front end of the sheet bundle S as the sheet bundle S moves forward to the discharge tray 23b. When the sensor D1 detects the front end of the sheet bundle S, CPU 24a causes the motor M1 and M2 to rotate the roller pairs 701 and 702 (FIG. 28). In addition, the CPU 24a causes the motor M4 to rotate the flapper F1 in the clockwise direction and the motor M5 to rotate the flapper F2 in the counter-clockwise direction to guide the sheet bundle S toward the sheet guide P2 (FIG. 29). Next, when the sensor D2 detects the front end of the sheet bundle S, the CPU 24a causes the motor M2 to rotate the roller pairs 702 in a first rotational direction to pull the sheet bundle S into the sheet guide P2 (FIG. 29). After the rear end of the sheet bundle S passes the sensor D2, the CPU 24a causes the motor M5 to rotate the flapper F2 in clockwise direction and causes the motor M2 to rotate the roller pair 702 in a second rotational direction (opposite the first rotational direction) to feed the sheet bundle S into the sheet guide P1 again and the motor M3 to rotate the roller pair 703 to discharge the sheet bundle S toward the discharge tray 23b (FIG. 30). When the sheet bundle S is discharged onto the discharge tray 23b after being reversed, the stapled portion Q is located at the front end of the sheet bundle.

In the second embodiment, image forming system 1′ performs the reversing operation to avoid overlap of the stapled parts in the stacking direction of the sheet bundles in the sheet bundles.

Hereinafter, modifications of the embodiments will be described.

The invention is not limited to the configuration in which the processing unit 22 includes the offset unit 40. For example, the discharge unit 23 may be provided with the offset unit 40.

The invention is not limited to the configuration in which the binding unit 30 performs binding with a needle. For example, the binding unit 30 may perform binding with paper (so-called needle-free stapling).

The invention is not limited to the configuration in which the control unit controls the distribution of the binding positions by making the image forming apparatus 2 and the post-processing apparatus 3 cooperate. For example, the post-processing apparatus 3 may independently control the distribution of the binding positions. For example, the post-processing apparatus 3 may be provided with a CPU which is similar to that of the image forming apparatus 2 or a HDD.

According to at least one embodiment described above, the image forming system 1 includes the printer unit 13, the binding unit 30, and the control unit. The printer unit 13 forms an image on a sheet S. The binding unit 30 staples the sheets S each having the image formed thereon together. The control unit controls the printer unit 13 and the binding unit 30 such that binding positions related to a first sheet S and a second sheet S are distributed in the first direction V1 or the second direction V2. By virtue of the configuration, the following effects are achieved. By distributing the binding positions related to the first sheet S and the second sheet S in the first direction V1 or the second direction V2, the sheet bundles are continuously discharged to the discharge tray 23a or 23b, and it is possible to suppress protrusion of the stapled parts even when the sheet bundles are stacked. Accordingly, collapse of the stacked sheet bundles can be suppressed.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. A post-processing apparatus comprising:
a binding unit configured to bind a plurality of sheets together at a binding position of the sheets to forma sheet bundle;
a tray;
a conveying unit configured to convey the sheet bundle along a first path toward the tray; and
a reversing unit arranged along the first path between the conveying unit and the tray, the reversing unit including a second path and being controlled to convey the sheet bundle from the first path to the second path and then from the second path to the first path to reverse a surface of the sheet bundle from a face-up position to a face-down position.

2. The apparatus according to claim 1, wherein the binding unit is configured to bind an upstream side end of the sheet bundle.

3. The apparatus according to claim 1, wherein the reversing unit includes first and second flappers that are controlled to direct the sheet bundle from the first path to the second path.

4. The apparatus according to claim 3, wherein the second flapper is controlled to be in a first angular position when directing the sheet bundle from the first path to the second path and in a second angular position to direct the sheet bundle from the second path to the first path.

5. The apparatus according to claim 4, wherein the first path extends along a first conveyance guide extending from the binding unit to the tray and the second path extends along a second conveyance guide that branches from the first conveyance guide at a location of the first flapper and merges with the first conveyance guide at a location between the second flapper and the tray.

6. The apparatus according to claim 5, wherein the reversing unit further includes a roller pair that rotates in a first direction to convey the sheet bundle from the first path to the second path and in a second direction opposite the first direction to convey the sheet bundle from the second path to the first path.

7. The apparatus according to claim 6, wherein
the reversing unit further includes a sensor between the roller pair and the location of the second flapper, and
when the sensor detects passage of a rear end of the sheet bundle, the roller pair is controlled to rotate in the second direction and the second flapper is controlled to be in the second angular position.

8. An image forming system comprising:
an image forming unit configured to form an image on each of a plurality of sheets to be bound;
a binding unit configured to bind the plurality of sheets together at a binding position of the sheets to forma sheet bundle;
a tray;
a conveying unit configured to convey the sheet bundle along a first path toward the tray; and
a reversing unit arranged along the first path between the conveying unit and the tray, the reversing unit including a second path and being controlled to convey the sheet bundle from the first path to the second path and then from the second path to the first path to reverse a surface of the sheet bundle from a face-up position to a face-down position.

9. The system according to claim 8, wherein the binding unit is configured to bind an upstream side end of the sheet bundle.

10. The system according to claim 8, wherein the reversing unit includes first and second flappers that are controlled to direct the sheet bundle from the first path to the second path.

11. The system according to claim 10, wherein the second flapper is controlled to be in a first angular position when directing the sheet bundle from the first path to the second path and in a second angular position to direct the sheet bundle from the second path to the first path.

12. The system according to claim 11, wherein the first path extends along a first conveyance guide extending from the binding unit to the tray and the second path extends along a second conveyance guide that branches from the first conveyance guide at a location of the first flapper and merges with the first conveyance guide at a location between the second flapper and the tray.

13. The system according to claim 12, wherein the reversing unit further includes a roller pair that rotates in a first direction to convey the sheet bundle from the first path to the second path and in a second direction opposite the first direction to convey the sheet bundle from the second path to the first path.

14. The system according to claim 13, wherein
the reversing unit further includes a sensor between the roller pair and the location of the second flapper, and
when the sensor detects passage of a rear end of the sheet bundle, the roller pair is controlled to rotate in the second direction and the second flapper is controlled to be in the second angular position.

15. A sheet processing method comprising the steps of:
binding a plurality of sheets together at a binding position of the sheets to form a sheet bundle;
conveying the sheet bundle along a first path toward a tray;
conveying the sheet bundle from the first path to the second path and then from the second path to the first path to reverse a surface of the sheet bundle from a face-up position to a face-down position.

16. The method according to claim 15, wherein binding an upstream side end of the sheet bundle.

17. The method according to claim 15, wherein conveying the sheet bundle from the first path to the second path by controlling first and second flappers to direct the sheet bundle from the first path to the second path.

18. The method according to claim 15, further comprising:
binding a plurality of sheets together at a binding position of the sheets to form a first sheet bundle;
conveying the first sheet bundle along a first path toward a tray;
conveying the first sheet bundle from the first path to the second path and then from the second path to the first path to reverse a surface of the first sheet bundle from a face-up position to a face-down position;
discharging the reversed first sheet bundle onto the tray;
binding a plurality of sheets together at a binding position of the sheets to form a second sheet bundle;
conveying the second sheet bundle along the first path toward a tray, without reversing;
discharging the second sheet bundle on the first sheet bundle, which is discharged on the tray.

19. The method according to claim 18, wherein binding an upstream side end of the sheet bundle.
